(19) United States
(12) Patent Application Publication
(10) Pub. No.: US 2026/0042339 A1
(43) Pub. Date: Feb. 12, 2026

(54) METHOD OF INSTALLING A FIXING MEMBER FOR A VEHICLE SIDE WINDOW SHADE TO A VEHICLE DOOR WINDOW FRAME

(71) Applicant: Tung-Hsin CHEN, Tainan City (TW)

(72) Inventor: Tung-Hsin CHEN, Tainan City (TW)

(21) Appl. No.: 19/116,833

(22) PCT Filed: Sep. 30, 2022
(86) PCT No.: PCT/CN2022/123271

§ 371 Date: Mar. 28, 2025

(51) Int. Cl. B60J 3/02

(52) U.S. Cl. CPC B60J 3/02

(57) ABSTRACT

A method of installing a fixing member for a vehicle side window shade to a vehicle door window frame is provided, and includes: attaching a first positioning member to the vehicle door window frame when the vehicle side window shade is manually positioned relative to the vehicle door window frame at a proper position where the vehicle side window shade completely covers a side window, so that the first positioning member corresponds to a connecting member of the vehicle side window shade in position; attaching a second positioning member formed with an installation opening to the vehicle door window frame so that the installation opening corresponds to the first positioning member in position; and adhering the fixing member to a mounting area of the vehicle door window frame exposed from the installation opening through an adhesive layer disposed on the fixing member.

### FIELD

The disclosure relates to a method of installing a fixing member, and more particularly to a method of installing a fixing member for a vehicle side window shade to a vehicle door window frame.

### BACKGROUND

In a conventional method of installing a vehicle sunshade to a vehicle door window frame, a magnetic attraction seat is manually disposed on the vehicle door window frame. The vehicle sunshade is provided with one or more magnetic members that exert a magnetic attraction force between the magnetic attraction seat and the magnetic member(s), so that the vehicle sunshade is attracted to the vehicle door window frame and covers a vehicle window.

In the process of disposing the magnetic attraction seat, positioning of the vehicle sunshade relative to the vehicle door window frame needs to be estimated before the magnetic attraction seat can be adhered to the vehicle door window frame. However, this estimation is only an approximation, such that when the vehicle sunshade is finally attached to the vehicle door window frame, it may not completely cover the vehicle window due to inaccurate positioning.

### SUMMARY

Therefore, an object of the disclosure is to provide a method of installing a fixing member for a vehicle side window shade to a vehicle door window frame that can alleviate at least one of the drawbacks of the prior art.

According to the disclosure, the fixing member installed to the vehicle door window frame is used to connect a connecting member of the vehicle side window shade to fix the vehicle side window shade to the vehicle door window frame. The vehicle door window frame defines a widthwise direction, a thickness-wise direction and a lengthwise direction. The method includes steps of: a) when the vehicle side window shade is manually positioned relative to the vehicle door window frame at a proper position with respect at least to the widthwise direction where the vehicle side window shade completely covers a side window, attaching a first positioning member to the vehicle door window frame in a manner that the first positioning member extends in the widthwise direction and that the first positioning member is aligned with and adjacent to the connecting member of the vehicle side window shade in one of the thickness-wise direction and the lengthwise direction; b) attaching a second positioning member to the vehicle door window frame in a manner that the second positioning member covers the first positioning member and that an installation opening formed in the second positioning member is aligned with and adjacent to the first positioning member in said one of the thickness-wise direction and the lengthwise direction, such that a surface portion of the vehicle door window frame exposed from the installation opening serves as a mounting area; and c) adhering the fixing member to the mounting area of the vehicle door window frame through an adhesive layer disposed on the fixing member.

### BRIEF DESCRIPTION OF THE DRAWINGS

Other features and advantages of the disclosure will become apparent in the following detailed description of the embodiments with reference to the accompanying drawings. It is noted that various features may not be drawn to scale.

FIG. 1 is a flow chart illustrating the embodiment of a method of installing a fixing member for a vehicle side window shade to a vehicle door window frame according to the disclosure.

FIG. 2 is a schematic view illustrating the fixing member mounted on a bottom side of an upper portion of the vehicle door window frame and the vehicle side window shade in the embodiment.

FIGS. 3 to 6 are schematic views respectively illustrating results of performing the steps in FIG. 1.

FIG. 7 is a fragmentary sectional view illustrating how the vehicle side window shade is fixed to the vehicle door window frame in the embodiment.

FIG. 8 is a schematic view illustrating how a variation of a second positioning member is used in the embodiment.

FIG. 9 is a schematic view illustrating how the fixing member is mounted on an inner lateral side of the upper portion of the vehicle door window frame according to a variation of the embodiment.

FIG. 10 is a fragmentary sectional view illustrating how the vehicle side window shade is fixed to the vehicle door window frame in the variation of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

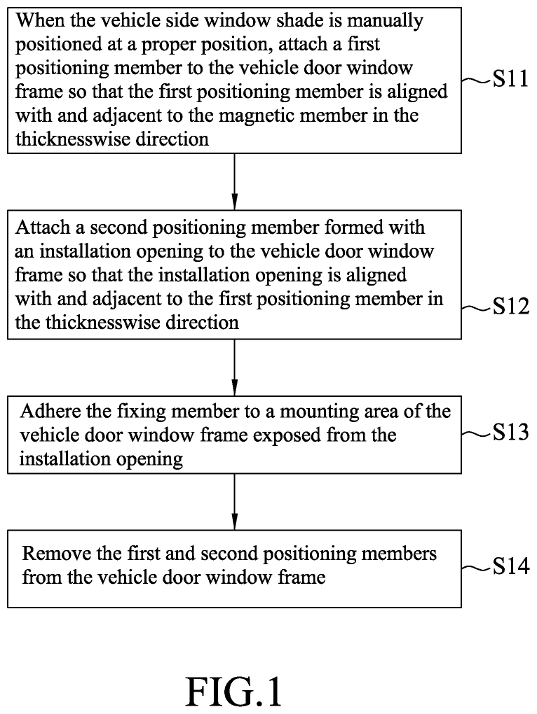

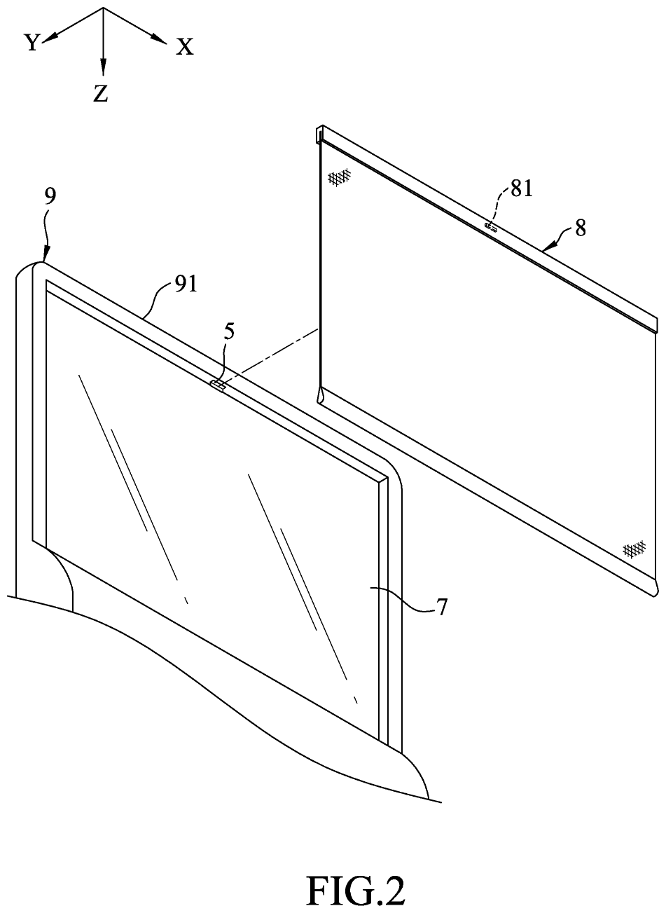

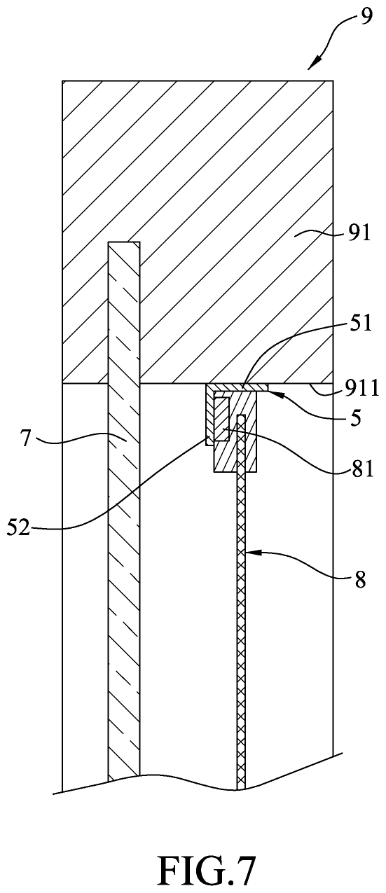

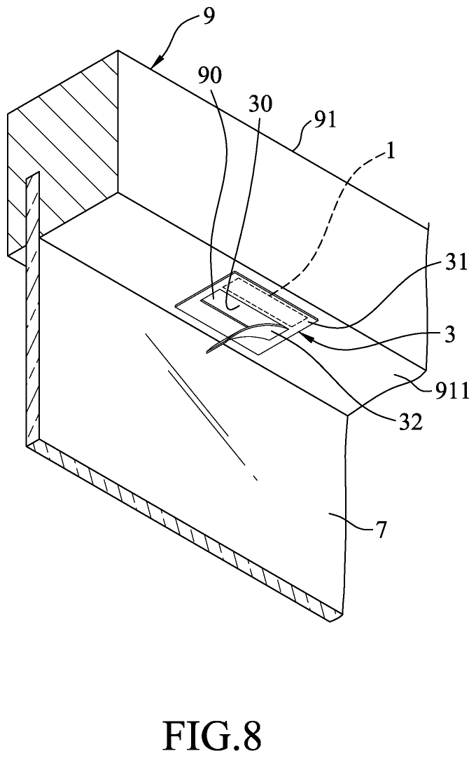

Referring to FIG. 1, FIG. 2 and FIG. 7, the embodiment of a method of installing a fixing member 5 for a vehicle side window shade 8 to a vehicle door window frame 9 of the disclosure is shown. The fixing member 5 installed to the vehicle door window frame 9 according to the embodiment is used to connect a connecting member of the vehicle side window shade 8 to fix the vehicle side window shade 8 to the vehicle door window frame 9. In this embodiment, the vehicle side window shade 8 includes, for example, an embedded magnetic member 81 serving as the connecting member. The fixing member 5 has, for example, an inverted L-shaped cross-section, is made of a magnetic material, and includes a first wall portion 51 and a second wall portion 52 perpendicular to each other (see FIG. 7). The vehicle door inner frame 9 defines a widthwise direction (X), a thickness-wise direction (Y) and a lengthwise direction (Z) that are orthogonal to each other, and includes, for example, an upper portion 91 extending in the widthwise direction (X) (see FIG. 2).

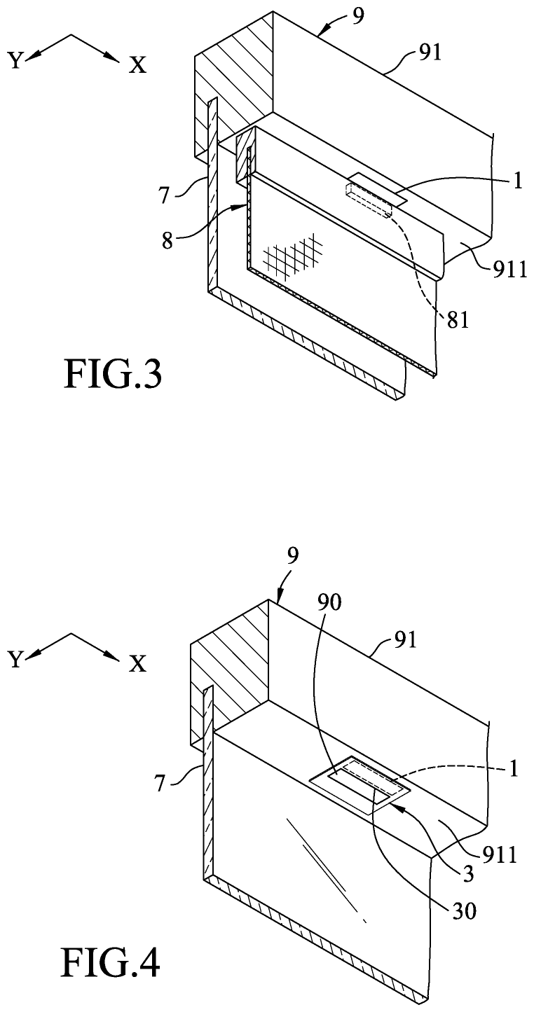

Referring to FIG. 1, the embodiment of the method is shown to include steps S11˜S14, which will be described in detail below in connection with FIGS. 3 to 6.

Referring to FIG. 3, in step S11, when the vehicle side window shade 8 is manually positioned relative to the vehicle door window frame 9 at a proper position with respect to the widthwise direction (X) and the thickness-wise direction (Y) where the vehicle side window shade 8 completely covers a side window 7, a first positioning member 1 is attached to the vehicle door window frame in a manner that the first positioning member 1 extends in the widthwise direction (X) and that the first positioning member 1 is aligned with and adjacent to the connecting member (i.e., the magnetic member 81) of the vehicle side window shade 8 in the thickness-wise direction (Y), and thereafter the vehicle side window shade 8 is moved away from the proper position.

It is noted that, in this embodiment, the vehicle side window shade 8 is to be disposed on the bottom of the upper portion 91 of the vehicle door window frame 9. The first positioning member 1 is rectangular in shape, and is preferably coated with an adhesive (not shown), such as a non-permanent adhesive, to form a reusable adhesive pad so that the first positioning member 1 is adhered to a bottom side 911 of the upper portion 91 of the vehicle door window frame 9.

Referring to FIG. 4, in step S12, a second positioning member 3, which is formed with an installation opening 30, is attached to the vehicle door window frame 9 in a manner that the second positioning member 3 covers the first positioning member 3 and that the installation opening 30 is aligned with and adjacent to the first positioning member 3 in the thickness-wise direction (Y), such that a surface portion of the vehicle door window frame 9 exposed from the installation opening 30 serves as a mounting area 90. In this embodiment, the mounting area 90 is located on the bottom side 911 of the upper portion 91 of the vehicle door window frame 9.

In this embodiment, the installation opening 30 is rectangular in shape, and the installation opening 30 and the first positioning member 1 have the same length in the widthwise direction (X). Preferably, when one side of the installation opening 30 extending in the widthwise direction (X) is disposed adjacent to one side of the first positioning member 1 extending in the widthwise direction (X), the second positioning member 3 is attached to the bottom side 911 of the upper portion 91 of the vehicle door window frame 9 to completely cover the first positioning member 1. The second positioning member 3 is preferably coated with an adhesive (not shown), such as a non-permanent adhesive, to form a reusable adhesive pad so that the second positioning member 1 is adhered to the bottom side 911 of the upper portion 91 of the vehicle door window frame 9 to completely cover the first positioning member 1.

Since the first positioning member 1 is first aligned with and placed adjacent to the magnetic member 81 of the vehicle side window shade 8, which is positioned at the proper position relative to the thickness-wise direction (Y), and then the installation opening 30 in the second positioning member 3 is aligned with the first positioning member 1, the mounting area 90 is thus accurately decided.

FIG. 8 illustrates a variation of the second positioning member 3 that includes a central portion 32 having the same shape as that of the installation opening 30, and a peripheral portion 31 surrounding and detachably connected to the central portion 32 through a perforated line or tear-off line therebetween. After the central portion 32 is detached from the peripheral portion 31 to form the installation opening 30, the peripheral portion 31 is attached to the vehicle door window frame 9 and covers the first positioning member 1.

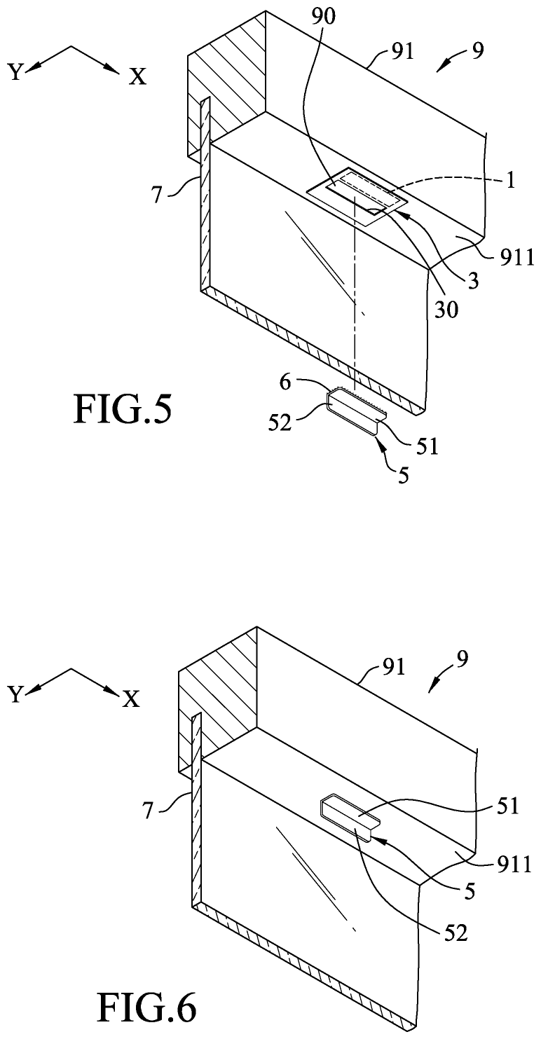

Referring to FIG. 5, in step S13, the fixing member 5 is adhered to the mounting area 90 of the vehicle door window frame 9 through an adhesive layer 6 disposed on the fixing member 5. In this embodiment, the first wall portion 51 of the fixing member 5 serves as a mounting wall portion that is allowed to pass through the installation opening 30 and that has a wall surface disposed with the adhesive layer 6, such that the first wall portion 51 of the fixing member 5 is adhered to the mounting area 90 of the vehicle door window frame 9 via the adhesive layer 6.

Referring to FIG. 6, in step S14, the first positioning member 1 and the second positioning member 3 are removed from the vehicle door window frame 9.

In this embodiment, since the first positioning member 1 and the second positioning member 3 can be reusable adhesive pads, they can be easily removed after completing the installation of the fixing member 5.

After the fixing member 5 is installed to the vehicle door window frame 9, the magnetic member 81 of the vehicle side window shade 8 can be aligned with and magnetically attracted to the fixing member 5 (see FIG. 7), such that the vehicle side window shade 8 is fixed to the vehicle door window frame 9 and can completely cover the vehicle window 7.

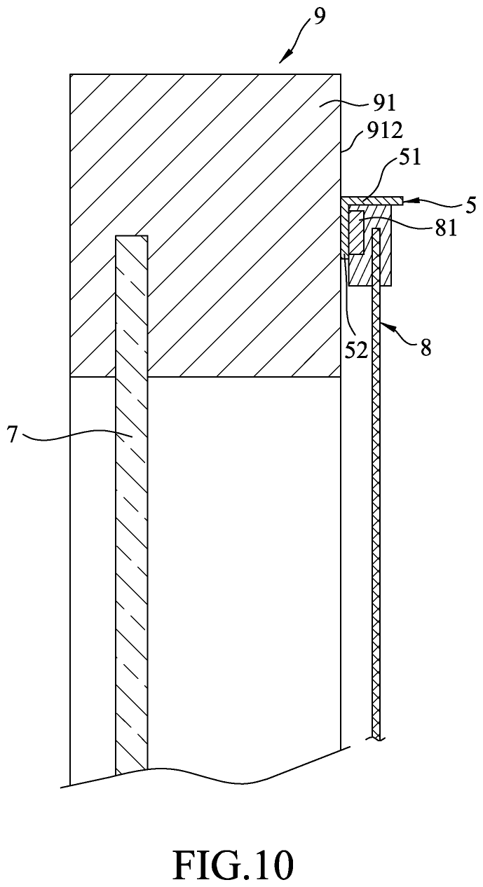

However, if the vehicle side window shade 8 is to be disposed on an inner lateral side 912 of the upper portion 91 of the vehicle door window frame 9, the fixing member 5 can be mounted instead on the inner lateral side 912 of the upper portion 91 of the vehicle door window frame 9 according to a variation of the embodiment (see FIG. 10).

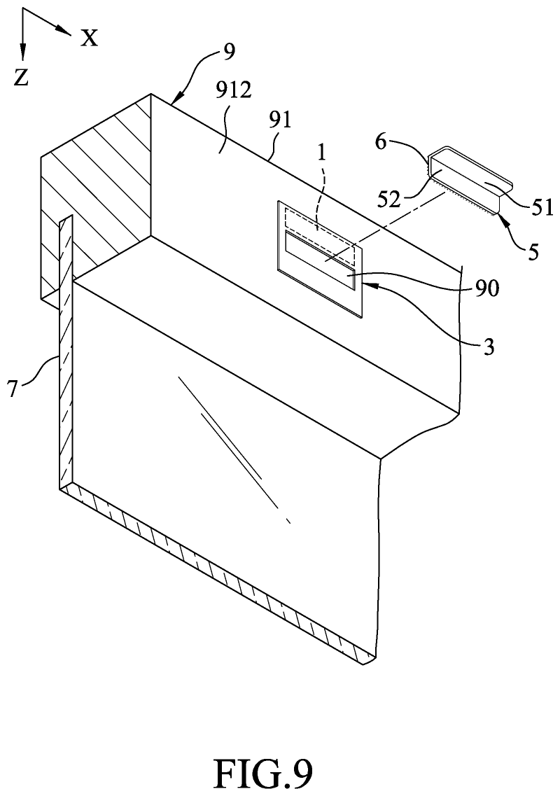

In the variation of the embodiment, referring to FIG. 9, when the vehicle side window shade 8 is manually positioned relative to the vehicle door window frame 9 at a proper position with respect to the widthwise direction (X) and the lengthwise direction (Z) where the vehicle side window shade 8 completely covers a side window 7, the first positioning member 1 is attached to the inner lateral side 912 of the upper portion 91 of the vehicle door window frame 9 in a manner that the first positioning member 1 extends in the widthwise direction (X) and that the first positioning member 1 is aligned with and adjacent to the magnetic member 81 of the vehicle side window shade 8 in the lengthwise direction (Z) (step S11). Further, the second positioning member 3 is attached to the inner lateral side 912 of the upper portion 91 of the vehicle door window frame 9 in a manner that the second positioning member 3 covers the first positioning member 3 and that the installation opening 30 is aligned with and adjacent to the first positioning member 3 in the lengthwise direction (Z) (step S12). In this case, the mounting area 90 (a surface portion of the upper portion 91 exposed from the installation opening 30) is located in the inner lateral side 912 of the upper portion 91 of the vehicle door window frame 9. Moreover, the second wall portion 52 of the fixing member 5 serves as the mounting wall portion and is disposed with the adhesive layer 6 on a wall surface thereof, such that the second wall portion 52 of the fixing member 5 is adhered to the mounting area 90 of the vehicle door window frame 9 via the adhesive layer 6 (step S13).

In summary, since the first positioning member 1 is first attached to the vehicle door window frame 9 and is aligned with and adjacent to the magnetic member 81 of the vehicle side window shade 8, which is manually positioned at a desired proper position, the mounting area 90 of the vehicle door window frame 9 can be easily and accurately decided by having the installation opening 30 of the second positioning member 3 be aligned with and adjacent to the first positioning member 1. Therefore, the fixing member 5 can be installed accurately on the mounting area 90 that allows the vehicle side window shade 8 to be subsequently fixed to the vehicle door window frame 9 and completely cover the side window 7. Therefore, the accuracy of installation of the fixing member 5 can be improved. The object of the disclosure can indeed be achieved.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

1. A method of installing a fixing member for a vehicle side window shade to a vehicle door window frame, the fixing member installed to the vehicle door window frame being used to connect a connecting member of the vehicle side window shade to fix the vehicle side window shade to the vehicle door window frame, the vehicle door window frame defining a widthwise direction (X), a thickness-wise direction (Y) and a lengthwise direction (Z), the method comprising steps of:
a) when the vehicle side window shade is manually positioned relative to the vehicle door window frame at a proper position with respect at least to the widthwise direction (X) where the vehicle side window shade completely covers a side window, attaching a first positioning member to the vehicle door window frame in a manner that the first positioning member extends in the widthwise direction (X) and that the first positioning member is aligned with and adjacent to the connecting member of the vehicle side window shade in one of the thickness-wise direction (Y) and the lengthwise direction (Z);
b) attaching a second positioning member to the vehicle door window frame in a manner that the second positioning member covers the first positioning member and that an installation opening formed in the second positioning member is aligned with and adjacent to the first positioning member in said one of the thickness-wise direction (Y) and the lengthwise direction (Z), such that a surface portion of the vehicle door window frame exposed from the installation opening serves as a mounting area; and
c) adhering the fixing member to the mounting area of the vehicle door window frame through an adhesive layer disposed on the fixing member.

2. The method of claim 1, wherein:
the widthwise direction (X), the thickness-wise direction (Y) and the lengthwise direction (Z) are orthogonal to each other, and the installation opening and the first positioning member are rectangular in shape and have the same length in the widthwise direction (X); and
in step b), when one side of the installation opening extending in the widthwise direction (X) is disposed adjacent to one side of the first positioning member extending in the widthwise direction (X), the second positioning member is attached to the vehicle door window frame to cover the first positioning member.

3. The method of claim 1, wherein, in step b), the first positioning member is completely covered by the second positioning member.

4. The method of claim 1, wherein the fixing member includes a mounting wall portion that is allowed to pass through the installation opening, and the mounting wall portion has a wall surface that is disposed with the adhesive layer thereon, such that, in step c), the mounting wall portion of the fixing member is attached to the mounting area of the vehicle door window frame through the adhesive layer.

5. The method of claim 4, wherein the fixing member includes a first wall portion, and a second wall portion perpendicular to the first wall portion, one of the first and second wall portions, serving as the mounting wall portion.

6. The method of claim 1, further comprising a step of: d) removing the first positioning member and the second positioning member from the vehicle door window frame.

7. The method of claim 1, wherein:
the second positioning member includes a central portion having the same shape as that of the installation opening, and a peripheral portion surrounding and detachably connected to the central portion; and
in step b), after the central portion is detached from the peripheral portion to form the installation opening, the peripheral portion is attached to the vehicle door window frame and covers the first positioning member.

8. The method of claim 1, wherein, in step a), the first positioning member coated with an adhesive is adhered to the vehicle door window frame.

9. The method of claim 1, wherein, in step b), the second positioning member coated with an adhesive is adhered to the vehicle door window frame.
